(19) United States
(12) Patent Application Publication
(10) Pub. No.: US 2019/0153174 A1
(43) Pub. Date: May 23, 2019

(54) FIBERGLASS CONTAINING COMPOSITES WITH IMPROVED RETAINED GLASS FIBER LENGTH, IMPACT STRENGTH, AND TENSILE PROPERTIES

(71) Applicant: PPG INDUSTRIES OHIO, INC., Cleveland, OH (US)

(72) Inventors: Piet LEEGSTRA, Zuidlaren (NL); Hong LI, Sewickley, PA (US)

(73) Assignee: Elictric Glass Fiber America, LLC, Shelby, NC (US)

(21) Appl. No.: 16/091,246

(22) PCT Filed: Mar. 31, 2017
(86) PCT No.: PCT/US2017/025342

§ 371 Date: Oct. 4, 2018

Related U.S. Application Data
(60) Provisional application No. 62/317,880, filed on Apr. 4, 2016.

(51) Int. Cl. C08J 5/08; C03C 3/087

(52) U.S. Cl. CPC C08J 5/08; C03C 3/087; C08J 2377/00; C08L 75/06; C03C 2201/50; C03C 2201/54; C03C 2201/60; C03C 2201/42

(57) ABSTRACT

Composites comprising glass compositions and, in particular embodiments, glass fibers. Embodiments of the present invention relate to composite comprising a recycled material and a glass fiber. Additional embodiments of the present invention relate to methods for improving the properties of composites.

### CROSS-REFERENCE TO RELATED APPLICATION

This application claims priority to U.S. Provisional Patent Application No. 62/317,880, filed Apr. 4, 2016, which is incorporated herein by reference in its entirety.

### FIELD OF THE INVENTION

The present invention relates to composites comprising glass compositions and, in particular embodiments, glass fibers. Embodiments of the present invention relate to composites comprising a recycled material and a glass fiber. Additional embodiments of the present invention relate to methods for improving the properties of composites.

### BACKGROUND OF THE INVENTION

Glass fibers have been used to reinforce various polymeric resins. Some commonly used glass compositions for use in reinforcement applications include the “E-glass” and “D-glass” families of compositions.

### SUMMARY

Various embodiments of the present invention provide composites comprising glass compositions, fiberizable glass compositions, and/or glass fibers formed from such compositions. In various embodiments, a composite of the present invention comprises a recycled material and a glass composition. In some embodiments, the glass composition comprises a glass fiber. In some embodiments, the glass composition is chopped. In certain embodiments, the glass composition further comprises a binder. Additional embodiments of the present invention provide methods for reinforcing a composite and articles of manufacture comprising a composite of the present invention.

As used herein, a recycled material may comprise a recycled material, a material intended for a consumer that is not delivered, sold or otherwise used by a consumer, and/or material from a production process for an article (e.g. waste raw material, scrap). A recycled material may comprise: paper, a plastic, a natural and/or synthetic rubber, carpet, carpet backing, and/or additional inorganic or organic material. The recycled material may be recovered or recycled from discarded household, commercial, or industrial packages or products. In various embodiments, the recycled material comprises a polymeric material. In some embodiments, the polymeric material comprises nylon (polyamide).

The glass compositions, fiberizable glass compositions, and glass fibers in various embodiments of the present invention, when compounded in recycled material, may result in one or more of the following advantageous features, as compared to compounding of recycled material with current commercially available glass compositions: increased glass fiber length, increased impact strength notched, and increased impact strength unnotched. Additional benefits of embodiments of the present invention may include increased tensile strength, increased tensile modulus, and increased tensile elongation at break. Embodiments of the present invention may be advantageous for automotive manufacturing, among other potential applications. Additional advantages of embodiments of the present invention will be apparent to those of ordinary skill in the art from the descriptions provided herein.

The present invention also provides methods for improving the properties of composites comprising compounding certain glass compositions, fiberizable glass compositions, and/or glass fibers in a recycled material. Embodiments include methods for improving glass fiber length, impact strength notched, and/or impact strength unnotched in a composite. Embodiments further include methods for improving tensile strength, tensile modulus, and/or tensile elongation at break in a composite.

The present invention also provides articles of manufacture produced from a composite of the present invention and/or produced from a method of the present invention. Examples of articles of manufacture include, but are not limited to, vehicle parts, including automotive, truck, aircraft and/or boat parts; construction materials; electronic materials; and/or virtually any other article of manufacture currently produced with fiberglass reinforcement.

The features and embodiments of the present invention are described in greater detail in the Detailed Description that follows.

### DETAILED DESCRIPTION

Unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

The present invention relates generally to reinforcement of a composite with glass compositions, such as a mixture of chopped glass fibers. In reinforcement and other applications, certain mechanical properties of glass fibers or of composites reinforced with glass fibers can be important. However, in some instances, the mechanical properties of the glass fibers limit the improvements in the mechanical properties of the reinforced material.

For example, in the case of reinforcing composites produced with recycled materials, the recycled materials may contain constituents, e.g. titanium dioxide (TiO₂) that have a greater hardness than a glass composition. For example, certain types of the aforementioned E-glass have a lower hardness than TiO₂. The presence of TiO₂ may reduce the glass fiber length due to contact damage between TiO₂ particles and the glass fibers through the process of composite making and other mechanical properties of E-glass reinforced recycled material-containing composites.

In an embodiment, a composite of the present invention comprises a recycled material and a glass composition. A recycled material may comprise: paper, a plastic, a natural and/or synthetic rubber, and/or additional inorganic or organic material. The recycled material may be recovered or recycled from discarded household, commercial, or industrial packages or products. In various embodiments, the recycled material comprises a polymeric material. In some embodiments, the polymeric material comprises nylon (polyamide).

Recycled polymeric materials may be derived from many sources. One of the more plentiful and less expensive sources is carpet, such as from manufacturing waste, precycled waste, or recycled waste. Whole carpet waste is produced during manufacture from unsold merchandise, and from recycled disposal. Typically, whole carpet comprises nylon, polypropylene, or PET pile or tufts, at least one backing formed from one or more polyolefins such as polypropylene, and an adhesive material of styrene-butadiene rubber (SBR) applied as a latex and filled with an inorganic filler such as calcium carbonate.

Certain codes may be used to identify polymeric materials, including recycled polymeric materials. The codes include the following.

| Code | Abbreviation | Full Name | Examples of Sources |
|---|---|---|---|
| 1 | PETE | Polyethylene Terephthalate | Bottles (Beer, Soft Drink, Water, Sports |
| | | (PET) | Drinks etc.), Food and Produce Containers |
| 2 | HDPE | High Density Polyethylene | Milk Bottles, Food and Cosmetic |
| | | | Containers, Pails, Grocery Bags |
| 3 | V | Polyvinyl Chloride (PVC | Pipes, Tubing, Wire Insulation |
| | | or simply Vinyl) | |
| 4 | LDPE | Low Density Polyethylene | Bags and Film |
| 5 | PP | Polypropylene | Food and drug containers |
| 6 | PS | Polystyrene | Plates, Cutlery, CD Holders, Food |
| | | | Packaging, Expanded Foam |
| 7 | Other | | |

Recycled material may also comprise cellulosic materials, for example from paper or wood. These types of materials may comprise: recycled material (PCW)—waste paper that has served its intended purpose and has been separated from solid waste to be recycled into new paper; de-inked material—waste paper that has had the ink, filler, coatings, etc. removed as a step in the production of recycled paper (this includes magazines and newspapers that were printed but never sold); post-mill material—paper waste generated in converting and printing done by a facility other than the paper mill (this does not include mill waste or wood chips); recovered, pre-consumer and wastepaper; and non-wastestream materials such as mill broke, other mill wastes, and wood chips.

In some embodiments, the glass composition comprises one or more, in chopped and/or unchopped form, of a glass fiber, a glass fabric, a glass yarn and/or portions thereof. The glass composition may further comprise a binder.

In certain embodiments, a composite of the present invention comprises a recycled material and a glass composition having a Vickers hardness greater than or equal to 4.4 gigapascals (GPa). In some embodiments, the amount of recycled material in a composite may be expressed as a function of the amount of glass composition in the composite. In some embodiments, the composite comprises 0.1 to 10 parts by weight recycled material per part by weight glass composition. In some embodiments, the composite comprises 0.1 to 8 parts by weight recycled material per part by weight glass composition. In some embodiments, the composite comprises 0.1 to 5 parts by weight recycled material per part by weight glass composition. In some embodiments, the composite comprises 1 to 5 parts by weight recycled material per part by weight glass composition. In some embodiments, the composite comprises 1 to 3 parts by weight recycled material per part by weight glass composition.

In some embodiments, the glass composition comprises glass fibers. In some embodiments, the glass composition comprises chopped glass fibers. In some embodiments, the recycled material comprises nylon (polyamide). In some embodiments, the glass composition may comprise a binder. In some embodiments, a composite of the present invention may further include a polyethylene-based maleic anhydride impact modifier/chain extender.

In certain embodiments, the present invention provides a composite comprising a recycled nylon (polyamide) and a glass composition having a binder, wherein the glass composition is suitable for fiber forming and comprises:
from 60 to 62 weight percent SiO₂;
from 14 to 17 weight percent Al₂O₃;
from 14 to 17.5 weight percent CaO;
from 6 to 8.75 weight percent MgO;
from 0 to 1 weight percent TiO₂; and
from 0.5 to 3 weight percent of other constituents;
and may further be:
substantially free of Na₂O;
have a total content of CaO and MgO (MgO+CaO content) greater than 21.5 weight percent;
a K₂O content of from 0 to 1 weight percent;
a Li₂O content of from 0 to 2 weight percent;
a total content of Na₂O, K₂O, and Li₂O (Na₂O+K₂O+Li₂O) of less than 1 weight percent; and/or
one or more rare earth oxides in an amount from 0.1 to 3.0 weight percent;
wherein the binder comprises:
from 6 to 8 weight percent of an aqueous dispersion of an aliphatic non-reactive polyester polyurethane;
from 4 to 6 weight percent poly(ethylene-alt-maleic anhydride);
from 0.1 to 1 weight percent γ-aminopropyltriethoxysilane;
from 0.1 to 1 weight percent neutralizing acid for aminosilane;
from 0.1 to 1 weight percent block copolymer of ethylene oxide and propylene oxide;
from 0.01 to 0.8 weight percent of a partially amidated polyethylene imine;
from 0.0001 to 0.01 weight percent defoamer; and
the remainder deionized water;
wherein the recycled nylon is present in an amount of from 0.1 to 10 parts by weight per part by weight glass composition.

Some embodiments of a composite comprising a glass composition can be characterized by the amount of SiO₂ present in the glass compositions. SiO₂ can be present, in some embodiments, in an amount from about 58 to about 62 weight percent, or from about 60 to about 62 weight percent, or from about 60 to about 61 weight percent. In some embodiments, SiO₂ can be present in an amount greater than 60 weight percent. In some embodiments, SiO₂ can be present in an amount less than 62 weight percent.

Some embodiments of a composite comprising a glass composition can be characterized by the amount of Al₂O₃ present in the glass compositions. Al₂O₃ can be present, in some embodiments, in an amount from about 14 to about 17 weight percent, or from about 14.5 to about 16 weight percent. In some embodiments, Al₂O₃ can be present in an amount from about 14 to about 15 weight percent, from about 15 to about 16 weight percent, or from about 16 to about 17 weight percent. In some embodiments, Al₂O₃ can be present in an amount greater than 14 weight percent. In some embodiments, Al₂O₃ can be present in an amount less than 17 weight percent.

Some embodiments of a composite comprising a glass composition can be characterized by the amount of CaO present in the glass compositions. CaO can be present, in some embodiments, in an amount from about 12 to about 17.5 weight percent, from about 13 to about 17.5 weight percent, or from about 14 to about 17.5 weight percent. In some embodiments, CaO can be present in an amount from about 12 to about 14 weight percent, from about 14 to about 16 weight percent, or from about 14.5 to about 16.5 weight percent. In some embodiments, CaO can be present in an amount greater than 12 weight percent, or greater than 14 weight percent. In some embodiments, CaO can be present in an amount less than 17.5 weight percent.

Some embodiments of a composite comprising a glass composition can be characterized by the amount of MgO present in the glass compositions. MgO can be present, in some embodiments, in an amount from about 4 to about 9 weight percent, from about 5 to about 9 weight percent, or from about 6 to about 9 weight percent. In some embodiments, MgO can be present in an amount from about 6 to about 8.75 weight percent, from about 6 to about 8 weight percent, from about 6 to about 7.5 weight percent, or from about 6.5 to about 7.5 weight percent. In some embodiments, MgO can be present in an amount greater than 4 weight percent, or greater than 6 weight percent. In some embodiments, MgO can be present in an amount less than 9 weight percent or less than 8.75 weight percent.

Some embodiments of a composite comprising a glass composition can be characterized by the total content of CaO and MgO (MgO+CaO content) present in the glass compositions. The (MgO+CaO) content can be present, in some embodiments, in an amount greater than about 16 weight percent, greater than about 18 weight percent, greater than about 20 weight percent, or greater than about 21 weight percent. The (MgO+CaO) content can be present, in some embodiments, in an amount greater than about 21.5 weight percent, greater than about 21.7 weight percent, or greater than about 22 weight percent.

Some embodiments of a composite comprising a glass composition can be characterized by the amount of Na₂O present in the glass compositions. Na₂O can be present, in some embodiments, in an amount less than about 2.5 weight percent, less than about 2 weight percent, or less than about 1 weight percent. In some embodiments, Na₂O can be present in an amount up to 0.5 weight percent. In some embodiments, the glass composition can be substantially free of Na₂O.

Some embodiments of a composite comprising a glass composition can be characterized by the amount of K₂O present in the glass compositions. K₂O can be present, in some embodiments, in an amount from about 0 to about 1.5 weight percent, from about 0 to about 1 weight percent, or from about 0 to about 0.5 weight percent. In some embodiments, K₂O can be present in an amount from about 0.1 to about 0.5 weight percent, or from about 0.1 to about 0.25 weight percent. In some embodiments, the glass composition can be substantially free of K₂O.

Some embodiments of a composite comprising a glass composition can be characterized by the amount of Li₂O present in the glass compositions. Li₂O can be present, in some embodiments, in an amount from about 0 to about 2 weight percent, from about 0 to about 1.5 weight percent, or from about 0 to about 1 weight percent. In some embodiments, Li₂O can be present in an amount less than about 0.7 weight percent, or less than about 0.5 weight percent. In some embodiments, the glass composition can be substantially free of Li₂O.

Some embodiments of a composite comprising a glass composition can be characterized by the total amount of alkali metal oxide content (R₂O; e.g., Na₂O+K₂O+Li₂O) present in the glass compositions. R₂O can be present, in some embodiments, in an amount up to about 2 weight percent. In some embodiments, R₂O can be present in an amount less than about 1.5 weight percent, less than about 1 weight percent, less than about 0.7 weight percent, or less than about 0.5 weight percent.

Some embodiments of a composite comprising a glass composition can be characterized by the amount of TiO₂ present in the glass compositions. TiO₂ can be present, in some embodiments, in an amount from about 0 to about 2 weight percent, from about 0 to about 1.5 weight percent, or from about 0 to about 1 weight percent. In some embodiments, TiO₂ can be present in an amount less than about 0.75 weight percent. In some embodiments, TiO₂ can be present in an amount from about 0.2 to about 0.75 weight percent. In some embodiments, the glass composition can be substantially free of TiO₂.

Some embodiments of a composite comprising a glass composition can be characterized by the amount of other constituents present in the glass compositions. Constituents in addition to those explicitly set forth in the compositional definition of the glasses of the present invention may be included even though not required, but in total amounts no greater than about 5 weight percent. In some embodiments, the total amounts of other constituents in the glass compositions comprises no greater than about 3 weight percent. In some embodiments, the total amounts of other constituents in the glass compositions is from about 0.5 to about 3 weight percent, from about 0.5 to about 2.5 weight percent, or from about 0.5 to about 2 weight percent.

Optional constituents include melting aids, fining aids, colorants, trace impurities and other additives known to those of skill in glassmaking. Other constituents can include, but are not limited to, various oxides such as B₂O₃, Fe₂O₃, ZrO₂, ZnO, BaO, SrO, and non-oxides such as F₂. Alternatively, some embodiments of the invention can be said to consist essentially of the named constituents.

Some embodiments of a composite comprising a glass composition can include B₂O₃ as an additional constituent in the glass compositions. B₂O₃ can be present, in some embodiments, in an amount from about 0 to about 4 weight percent, or from about 0 to about 2 weight percent. In some embodiments, B₂O₃ can be present in an amount less than about 1 weight percent, or less than about 0.5 weight percent. In some embodiments, the glass composition can be substantially free of B₂O₃.

Some embodiments of a composite comprising a glass composition can include Fe₂O₃ as an additional constituent in the glass compositions. Fe₂O₃ can be present, in some embodiments, in an amount from about 0 to about 1 weight percent, from about 0 to about 0.5 weight percent, or from about 0 to about 0.44 weight percent. In some embodiments, Fe₂O₃ can be present in an amount less than about 0.4 weight percent. In some embodiments, Fe₂O₃ can be present in an amount from about 0.2 to about 0.4 weight percent.

Some embodiments of a composite comprising a glass composition can include ZrO₂ as an additional constituent in the glass compositions. ZrO₂ can be present, in some embodiments, in an amount from about 0 to about 2 weight percent, or from about 0 to about 1 weight percent. In some embodiments, ZrO₂ can be present in an amount less than about 0.5 weight percent, or less than about 0.2 weight percent. In some embodiments, the glass composition can be substantially free of ZrO₂.

Some embodiments of a composite comprising a glass composition can include ZnO as an additional constituent in the glass compositions. ZnO can be present, in some embodiments, in an amount from about 0 to about 2 weight percent, or from about 0 to about 1 weight percent. In some embodiments, ZnO can be present in an amount less than about 0.5 weight percent. In some embodiments, the glass composition can be substantially free of ZnO.

Some embodiments of a composite comprising a glass composition can include BaO as an additional constituent in the glass compositions. BaO can be present, in some embodiments, in an amount from about 0 to about 2 weight percent, or from about 0 to about 1 weight percent. In some embodiments, BaO can be present in an amount less than about 0.5 weight percent. In some embodiments, the glass composition can be substantially free of BaO.

Some embodiments of a composite comprising a glass composition can include SrO as an additional constituent in the glass compositions. SrO can be present, in some embodiments, in an amount from about 0 to about 2 weight percent, or from about 0 to about 1 weight percent. In some embodiments, SrO can be present in an amount less than about 0.5 weight percent. In some embodiments, the glass composition can be substantially free of SrO.

Some embodiments of a composite comprising a glass composition can include F₂ as an additional constituent in the glass compositions. F₂ can be present, in some embodiments, in an amount from about 0 to about 1 weight percent, or from about 0 to about 0.5 weight percent. In some embodiments, F₂ can be present in an amount less than about 0.25 weight percent, or less than about 0.1 weight percent. In some embodiments, the glass composition can be substantially free of F₂.

The term “rare earth oxides” may be abbreviated as “RE₂O₃” and refers to oxides incorporating a rare earth metal and includes oxides of scandium (Sc₂O₃), yttrium (Y₂O₃), and the lanthanide elements (lanthanum (La₂O₃), cerium (Ce₂O₃ and CeO₂), praseodymium (Pr₂O₃), neodymium (Nd₂O₃), promethium (Pm₂O₃), samarium (Sm₂O₃), europium (Eu₂O₃ and EuO), gadolinium (Gd₂O₃), terbium (Tb₂O₃), dysprosium (Dy₂O₃), holmium (Ho₂O₃), erbium (Er₂O₃), thulium (Tm₂O₃), ytterbium (Yb₂O₃), and lutetium (Lu₂O₃). The glass compositions, in some embodiments, can comprise a combination of rare earth oxides (e.g., one or more of various rare earth oxides).

Some embodiments of a composite comprising a glass composition can be characterized by the total amount of RE₂O₃ present in the glass compositions. RE₂O₃ can be present, in some embodiments, in an amount from about 0 to about 3 weight percent, from about 0 to about 2 weight percent, or from about 0 to about 1 weight percent. RE₂O₃ can be present, in some embodiments, in an amount from about 0.5 to about 3 weight percent, or from about 0.5 to about 2 weight percent. In some embodiments, the glass composition can comprise greater than about 0.5 weight percent RE₂O₃. In some embodiments, the glass composition can comprise less than about 3 weight percent RE₂O₃. In some embodiments, the glass composition can be substantially free of RE₂O₃.

It should be understood that any component of a glass composition described as being present in amount between about 0 weight percent and another weight percent is not necessarily required in all embodiments. In other words, such components may be optional in some embodiments, depending of course on the amounts of other components included in the compositions. Likewise, in some embodiments, glass compositions can be substantially free of such components, meaning that any amount of the component present in the glass composition would result from the component being present as a trace impurity in a batch material and would only be present in amounts of about 0.2 weight percent or less.

Glass fibers for use in an embodiment of the present invention may be prepared in a conventional manner well known in the art, by blending the raw materials used to supply the specific oxides that form the composition of the fibers. Glass fibers according to the various embodiments of the present invention can be formed using any process known in the art for forming glass fibers, and more desirably, any process known in the art for forming essentially continuous glass fibers. For example and without limitation, the glass fibers according to non-limiting embodiments of the present invention can be formed using direct-melt or indirect-melt fiber forming methods. These methods are well known in the art and further discussion thereof is not believed to be necessary in view of the present disclosure. See, e.g., K. L. Loewenstein, The Manufacturing Technology of Continuous Glass Fibers, 3rd Ed., Elsevier, N.Y., 1993 at pages 47-48 and 117-234.

In some embodiments of the present invention, the composite may comprise fiber glass strands, yarns comprising fiber glass strands, and/or glass fiber fabrics. The glass composition may be chopped.

Fiber glass strands can comprise glass fibers of various diameters, depending on the desired application. In some embodiments, a fiber glass strand comprises at least one glass fiber having a diameter ranging from about 5 to about 24 μm. In other embodiments, the at least one glass fiber has a diameter ranging from about 5 to about 10 μm.

Fiber glass strands can be formed into yarn and rovings. Rovings can comprise assembled, multi-end, or single-end direct draw rovings. Rovings comprising fiber glass strands can comprise direct draw single-end rovings having various diameters and densities, depending on the desired application. In some embodiments, a roving comprising fiber glass strands may exhibit a density up to about 113 yards/pound.

Some embodiments of the present invention relate to a composite comprising a yarn produced from a fiber glass strands. A yarn may comprise at least one fiber glass strand as disclosed herein, wherein the at least one fiber glass strand is at least partially coated with a sizing composition. In some embodiments, the sizing composition is compatible with a thermosetting polymeric resin. In other embodiments, the sizing composition can comprise a starch-oil sizing composition. Yarns can have various linear mass densities, depending on the desired application. In some embodiments, a yarn of the present invention has a linear mass density from about 5,000 yards/pound to about 10,000 yards/pound. Yarns can have various twist levels and directions, depending on the desired application. In some embodiments, a yarn has a twist in the z direction from about 0.5 to about 2 turns per inch. In other embodiments, a yarn has a twist in the z direction of about 0.7 turns per inch. Yarns can be made from one or more strands that are twisted together and/or plied, depending on the desired application. Yarns can be made from one or more strands that are twisted together but not plied; such yarns are known as “singles.” Yarns can be made from one or more strands that are twisted together but not plied. In some embodiments, yarns comprise 1-4 strands twisted together. In other embodiments, yarns comprise 1 twisted strand.

Some embodiments of the present invention relate to composites comprising a fabric comprising at least one fiber glass strand. In some embodiments, a fabric can comprise at least one fiber glass strand comprising at least one of the glass compositions disclosed herein. In some embodiments, a fabric comprises a yarn as disclosed herein. Fabrics, in some embodiments, can comprise at least one fill yarn comprising at least one fiber glass strand as disclosed herein. Fabrics, in some embodiments, can comprise at least one warp yarn comprising at least one fiber glass strand as disclosed herein. In some embodiments, a fabric comprises at least one fill yarn comprising at least one fiber glass strand as disclosed herein and at least one warp yarn comprising at least one fiber glass strand as disclosed herein.

In some embodiments of the present invention comprising a fabric, the glass fiber fabric is a fabric woven in accordance with industrial fabric style no. 7781. In other embodiments, the fabric comprises a plain weave fabric, a twill fabric, a crowfoot fabric, a satin weave fabric, a stitch bonded fabric (also known as a non-crimp fabric), or a “three-dimensional” woven fabric.

Composites of the present invention can further comprise various polymeric resins, in addition to the recycled material, depending on the desired properties and applications. In some embodiments the polymeric resin comprises an epoxy resin. In other embodiments, the polymeric resin can comprise polyethylene, polypropylene, polyamide, polyimide, polybutylene terephthalate, polycarbonate, thermoplastic polyurethane, phenolic, polyester, vinyl ester, polydicyclopentadiene, polyphenylene sulfide, polyether ether ketone, cyanate esters, bis-maleimides, and thermoset polyurethane resins.

Composites of the present invention can be prepared by any suitable method known to one of ordinary skill in the art such as, but not limited to, vacuum assisted resin infusion molding, extrusion compounding, compression molding, resin transfer molding, and pultrusion. Composites of the present invention can be prepared using such molding techniques as known to those of ordinary skill in the art. In particular, embodiments of composites of the present invention that incorporate woven fiber glass fabrics can be prepared using techniques known to those of skill in the art for preparation of such composites.

Some composites of the present invention can be made using vacuum assisted resin infusion technology, as further described herein. A stack of glass fiber fabrics of the present invention may be cut to a desired size and placed on a silicone release treated glass table. The stack may then be covered with a peel ply, fitted with a flow enhancing media, and vacuum bagged using nylon bagging film. Next, the so-called “lay up” may be subjected to a vacuum pressure of about 27 inches Hg. Separately, the polymeric resin that is to be reinforced with the fiber glass fabrics can be prepared using techniques known to those of skill in the art for that particular resin. For example, for some polymeric resins, an appropriate resin (e.g., an amine-curable epoxy resin) may be mixed with an appropriate curing agent (e.g., an amine for an amine-curable epoxy resin) in the proportions recommended by the resin manufacturer or otherwise known to a person of ordinary skill in the art. The combined resin may then be degassed in a vacuum chamber for about 30 minutes and infused through the fabric preform until substantially complete wet out of the fabric stack is achieved. At this point, the table may be covered with heated blankets (set to a temperature of about 45-50° C.) for about 24 hours. The resulting rigid composites may then be de-molded and post-cured at about 250° F. for about 4 hours in a programmable convection oven. As is known to persons of ordinary skill in the art, however, various parameters such as degassing time, heating time, and post-curing conditions may vary based on the specific resin system used, and persons of ordinary skill in the art understand how to select such parameters based on a particular resin system.

As noted above, composites of the present invention can comprise a plurality of glass fibers. Glass fibers suitable for use in the present invention can have any appropriate diameter known to one of ordinary skill in the art, depending on the desired application. Glass fibers suitable for use in some embodiments of the present invention have a diameter from about 5 to about 11 μm. Glass fibers suitable for use in other embodiments of the present invention have a diameter of about 6 μm. For example, in some embodiments where glass fibers are to be used in composites for use in high energy impact applications, such as ballistic or blast resistance applications, the glass fibers can have a diameter of about 6 μm, although other glass fiber diameters could also be used.

The present invention also provides methods for improving the properties of composites. The improved property may include one or more of the following properties: increased glass fiber length, increased impact strength notched, and increased impact strength unnotched. Additional benefits of embodiments of the present invention may include increased tensile strength, increased tensile modulus, and increased tensile elongation at break.

In an embodiment, a method of the present invention comprises compounding a recycled material and a glass composition having a Vickers hardness greater than or equal to about 4.4 gigapascals (GPa). In some embodiments, from 0.1 to 10 parts by weight recycled material per part by weight glass composition are compounded. In some embodiments, from 1 to 8 parts by weight recycled material per part by weight glass composition are compounded. In some embodiments, from 0.1 to 5 parts by weight recycled material per part by weight glass composition are compounded. In some embodiments, from 1 to 5 parts by weight recycled material per part by weight glass composition are compounded. In some embodiments, from 1 to 3 parts by weight recycled material per part by weight glass composition are compounded.

In some embodiments, a method of the present invention comprises compounding a recycled nylon (polyamide) and a glass composition having a binder, wherein the glass composition is suitable for fiber forming and comprises:
from 60 to 62 weight percent SiO₂;
from 14 to 17 weight percent Al₂O₃;
from 14 to 17.5 weight percent CaO;
from 6 to 8.75 weight percent MgO;
from 0 to 1 weight percent TiO₂; and
from 0.5 to 3 weight percent of other constituents;
and may further be:
substantially free of Na₂O;
have a total content of CaO and MgO (MgO+CaO content) greater than 21.5 weight percent;
a K₂O content of from 0 to 1 weight percent;
a Li₂O content of from 0 to 2 weight percent;
a total content of Na₂O, K₂O, and Li₂O (Na₂O+K₂O+Li₂O) of less than 2 weight percent; and/or
one or more rare earth oxides in an amount from 0.1 to 3 weight percent;
wherein the binder comprises:
from 6 to 8 weight percent of an aqueous dispersion of an aliphatic non-reactive polyester polyurethane;
from 4 to 6 weight percent poly(ethylene-alt-maleic anhydride);
from 0.1 to 1 weight percent γ-aminopropyltriethoxysilane;
from 0.1 to 1 weight percent neutralizing acid for aminosilane;
from 0.1 to 1 weight percent block copolymer of ethylene oxide and propylene oxide;
from 0.01 to 0.8 weight percent partially amidated polyethylene imine;
from 0.0001 to 0.01 weight percent defoamer; and
the remainder deionized water;
wherein from 0.1 to 10 parts by weight recycled nylon are compounded per part by weight glass composition.

Some embodiments of a method for producing a composite comprising compounding a recycled material and a glass composition can be characterized by the amount of SiO₂ present in the glass compositions. SiO₂ can be present, in some embodiments, in an amount from about 58 to about 62 weight percent, or from about 60 to about 62 weight percent, or from about 60 to about 61 weight percent. In some embodiments, SiO₂ can be present in an amount greater than 60 weight percent. In some embodiments, SiO₂ can be present in an amount less than 62 weight percent.

Some embodiments of a method for producing a composite comprising compounding a recycled material and a glass composition can be characterized by the amount of Al₂O₃ present in the glass compositions. Al₂O₃ can be present, in some embodiments, in an amount from about 14 to about 17 weight percent, or from about 14.5 to about 16 weight percent. In some embodiments, Al₂O₃ can be present in an amount from about 14 to about 15 weight percent, from about 15 to about 16 weight percent, or from about 16 to about 17 weight percent. In some embodiments, Al₂O₃ can be present in an amount greater than 14 weight percent. In some embodiments, Al₂O₃ can be present in an amount less than 17 weight percent.

Some embodiments of a method for producing a composite comprising compounding a recycled material and a glass composition can be characterized by the amount of CaO present in the glass compositions. CaO can be present, in some embodiments, in an amount from about 12 to about 17.5 weight percent, from about 13 to about 17.5 weight percent, or from about 14 to about 17.5 weight percent. In some embodiments, CaO can be present in an amount from about 12 to about 14 weight percent, from about 14 to about 16 weight percent, or from about 14.5 to about 16.5 weight percent. In some embodiments, CaO can be present in an amount greater than 12 weight percent, or greater than 14 weight percent. In some embodiments, CaO can be present in an amount less than 17.5 weight percent.

Some embodiments of a method for producing a composite comprising compounding a recycled material and a glass composition can be characterized by the amount of MgO present in the glass compositions. MgO can be present, in some embodiments, in an amount from about 4 to about 9 weight percent, from about 5 to about 9 weight percent, or from about 6 to about 9 weight percent. In some embodiments, MgO can be present in an amount from about 6 to about 8.75 weight percent, from about 6 to about 8 weight percent, from about 6 to about 7.5 weight percent, or from about 6.5 to about 7.5 weight percent. In some embodiments, MgO can be present in an amount greater than 4 weight percent, or greater than 6 weight percent. In some embodiments, MgO can be present in an amount less than 9 weight percent or less than 8.75 weight percent.

Some embodiments of a method for producing a composite comprising compounding a recycled material and a glass composition can be characterized by the total content of CaO and MgO (MgO+CaO content) present in the glass compositions. The (MgO+CaO) content can be present, in some embodiments, in an amount greater than about 16 weight percent, greater than about 18 weight percent, greater than about 20 weight percent, or greater than about 21 weight percent. The (MgO+CaO) content can be present, in some embodiments, in an amount greater than about 21.5 weight percent, greater than about 21.7 weight percent, or greater than about 22 weight percent.

Some embodiments of a method for producing a composite comprising compounding a recycled material and a glass composition can be characterized by the amount of Na₂O present in the glass compositions. Na₂O can be present, in some embodiments, in an amount less than about 2.5 weight percent, less than about 2 weight percent, or less than about 1 weight percent. In some embodiments, Na₂O can be present in an amount up to 0.5 weight percent. In some embodiments, the glass composition can be substantially free of Na₂O.

Some embodiments of a method for producing a composite comprising compounding a recycled material and a glass composition can be characterized by the amount of K₂O present in the glass compositions. K₂O can be present, in some embodiments, in an amount from about 0 to about 1.5 weight percent, from about 0 to about 1 weight percent, or from about 0 to about 0.5 weight percent. In some embodiments, K₂O can be present in an amount from about 0.1 to about 0.5 weight percent, or from about 0.1 to about 0.25 weight percent. In some embodiments, the glass composition can be substantially free of K₂O.

Some embodiments of a method for producing a composite comprising compounding a recycled material and a glass composition can be characterized by the amount of Li₂O present in the glass compositions. Li₂O can be present, in some embodiments, in an amount from about 0 to about 2 weight percent, from about 0 to about 1.5 weight percent, or from about 0 to about 1 weight percent. In some embodiments, Li₂O can be present in an amount less than about 0.7 weight percent, or less than about 0.5 weight percent. In some embodiments, the glass composition can be substantially free of Li₂O.

Some embodiments of a method for producing a composite comprising compounding a recycled material and a glass composition can be characterized by the total amount of alkali metal oxide content (R₂O; e.g., Na₂O+K₂O+Li₂O) present in the glass compositions. R₂O can be present, in some embodiments, in an amount up to about 2 weight percent. In some embodiments, R₂O can be present in an amount less than about 1.5 weight percent, less than about 1 weight percent, less than about 0.7 weight percent, or less than about 0.5 weight percent.

Some embodiments of a method for producing a composite comprising compounding a recycled material and a glass composition can be characterized by the amount of TiO₂ present in the glass compositions. TiO₂ can be present, in some embodiments, in an amount from about 0 to about 2 weight percent, from about 0 to about 1.5 weight percent, or from about 0 to about 1 weight percent. In some embodiments, TiO₂ can be present in an amount less than about 0.75 weight percent. In some embodiments, TiO₂ can be present in an amount from about 0.2 to about 0.75 weight percent. In some embodiments, the glass composition can be substantially free of TiO₂.

Some embodiments of a method for producing a composite comprising compounding a recycled material and a glass composition can be characterized by the amount of other constituents present in the glass compositions. Constituents in addition to those explicitly set forth in the compositional definition of the glasses of the present invention may be included even though not required, but in total amounts no greater than about 5 weight percent. In some embodiments, the total amounts of other constituents in the glass compositions comprises no greater than about 3 weight percent. In some embodiments, the total amounts of other constituents in the glass compositions is from about 0.5 to about 3 weight percent, from about 0.5 to about 2.5 weight percent, or from about 0.5 to about 2 weight percent.

Optional constituents include melting aids, fining aids, colorants, trace impurities and other additives known to those of skill in glassmaking. Other constituents can include, but are not limited to, various oxides such as B₂O₃, Fe₂O₃, ZrO₂, ZnO, BaO, SrO, and non-oxides such as F₂. Alternatively, some embodiments of the invention can be said to consist essentially of the named constituents.

Some embodiments of a method for producing a composite comprising compounding a recycled material and a glass composition can include B₂O₃ as an additional constituent in the glass compositions. B₂O₃ can be present, in some embodiments, in an amount from about 0 to about 4 weight percent, or from about 0 to about 2 weight percent. In some embodiments, B₂O₃ can be present in an amount less than about 1 weight percent, or less than about 0.5 weight percent. In some embodiments, the glass composition can be substantially free of B₂O₃.

Some embodiments of a method for producing a composite comprising compounding a recycled material and a glass composition can include Fe₂O₃ as an additional constituent in the glass compositions. Fe₂O₃ can be present, in some embodiments, in an amount from about 0 to about 1 weight percent, from about 0 to about 0.5 weight percent, or from about 0 to about 0.44 weight percent. In some embodiments, Fe₂O₃ can be present in an amount less than about 0.4 weight percent. In some embodiments, Fe₂O₃ can be present in an amount from about 0.2 to about 0.4 weight percent.

Some embodiments of a method for producing a composite comprising compounding a recycled material and a glass composition can include ZrO₂ as an additional constituent in the glass compositions. ZrO₂ can be present, in some embodiments, in an amount from about 0 to about 2 weight percent, or from about 0 to about 1 weight percent. In some embodiments, ZrO₂ can be present in an amount less than about 0.5 weight percent, or less than about 0.2 weight percent. In some embodiments, the glass composition can be substantially free of ZrO₂.

Some embodiments of a method for producing a composite comprising compounding a recycled material and a glass composition can include ZnO as an additional constituent in the glass compositions. ZnO can be present, in some embodiments, in an amount from about 0 to about 2 weight percent, or from about 0 to about 1 weight percent. In some embodiments, ZnO can be present in an amount less than about 0.5 weight percent. In some embodiments, the glass composition can be substantially free of ZnO.

Some embodiments of a method for producing a composite comprising compounding a recycled material and a glass composition can include BaO as an additional constituent in the glass compositions. BaO can be present, in some embodiments, in an amount from about 0 to about 2 weight percent, or from about 0 to about 1 weight percent. In some embodiments, BaO can be present in an amount less than about 0.5 weight percent. In some embodiments, the glass composition can be substantially free of BaO.

Some embodiments of a method for producing a composite comprising compounding a recycled material and a glass composition can include SrO as an additional constituent in the glass compositions. SrO can be present, in some embodiments, in an amount from about 0 to about 2 weight percent, or from about 0 to about 1 weight percent. In some embodiments, SrO can be present in an amount less than about 0.5 weight percent. In some embodiments, the glass composition can be substantially free of SrO.

Some embodiments of a method for producing a composite comprising compounding a recycled material and a glass composition can include F₂ as an additional constituent in the glass compositions. F₂ can be present, in some embodiments, in an amount from about 0 to about 1 weight percent, or from about 0 to about 0.5 weight percent. In some embodiments, F₂ can be present in an amount less than about 0.25 weight percent, or less than about 0.1 weight percent. In some embodiments, the glass composition can be substantially free of F₂.

The term “rare earth oxides” refers to oxides incorporating a rare earth metal and includes oxides of scandium (Sc₂O₃), yttrium (Y₂O₃), and the lanthanide elements (lanthanum (La₂O₃), cerium (Ce₂O₃ and CeO₂), praseodymium (Pr₂O₃), neodymium (Nd₂O₃), promethium (Pm₂O₃), samarium (Sm₂O₃), europium (Eu₂O₃ and EuO), gadolinium (Gd₂O₃), terbium (Tb₂O₃), dysprosium (Dy₂O₃), holmium (Ho₂O₃), erbium (Er₂O₃), thulium (Tm₂O₃), ytterbium (Yb₂O₃), and lutetium (Lu₂O₃)).

Some embodiments of a method for producing a composite comprising compounding a recycled material and a glass composition can be characterized by the total amount of RE₂O₃ present in the glass compositions. RE₂O₃ can be present, in some embodiments, in an amount from about 0 to about 3 weight percent, from about 0 to about 2 weight percent, or from about 0 to about 1 weight percent. RE₂O₃ can be present, in some embodiments, in an amount from about 0.5 to about 3 weight percent, or from about 0.5 to about 2 weight percent. In some embodiments, the glass composition can comprise greater than about 0.5 weight percent RE₂O₃. In some embodiments, the glass composition can comprise less than about 3 weight percent RE₂O₃. In some embodiments, the glass composition can be substantially free of RE₂O₃.

Features of the glass composition and recycled material in embodiments of methods of the present invention are as described herein with respect to a composite of the present invention.

Compounding techniques and apparatuses as generally known in the art are suitable for use in a method of the present invention.

The present invention also provides articles of manufacture comprising a composite of the present invention and/or produced using a method of the present invention. The articles of manufacture may include additional elements.

The invention will be illustrated through the following series of non-limiting, specific embodiments. However, it will be understood by one of skill in the art that many other embodiments are contemplated by the principles of the invention.

### EXAMPLES

The glasses in these examples were made by melting mixtures of commercial and reagent grade chemicals (reagent grade chemicals were used only for the rare earth oxides) in powder form in gas-combustion furnace, and fibers in strand form were drawn directly from the molten glass subsequently in one step using commercial bushings. The compositions in the examples represent as-batched compositions. Commercial ingredients were used in preparing the glasses. In the batch calculation, special raw material retention factors were considered to calculate the oxides in each glass. The retention factors are based on years of glass batch melting and oxides yield in the glass as measured. Hence, the as-batched compositions illustrated in the examples are considered to be close to the measured compositions.

For compounding the following was utilized:

Extruder: Coperion Werner & Pfleiderer ZSK 30

Polymer Feeding Equipment: Colortonic CBS-A 6:1

Polymer Mass Flow: 8.4 kg/h

Chopped Strand Feeding Equipment: Colortronic CBS-CA 36:1

Chopped Strand Mass Flow: 3.6 kg/h

Screw speed extruder: 200 rpm

The recycled nylon pellets were pre-dried for 16 hr. at 80° C. The moisture content prior to compounding was 0.02 wt %.

Table 1 shows the adjusted parameters for injection molding:

TABLE 1
Injection Molding Parameters

| Mold | Unit | Axxicon/Tensile bar |
|---|---|---|
| Zone 3 (pellet inlet) | ° C. | 280 |
| Zone 2 | ° C. | 280 |
| Zone 1 | ° C. | 280 |
| Die | ° C. | 280 |
| Mold | ° C. | 95 |
| Injection Pressure | Bar | 80 |
| Hold Pressure | Bar | 30 |
| Back pressure | Bar | 0 |
| Injection speed | % | 50 |
| Cooling-time | S | 15 |
| Hold pressure-time | S | 10 |
| Screw Speed | rpm | 68 |

Table 2 describes a trial with fiberizable glass compositions mixed with a binder according to various embodiments of the present invention. Table 2 further describes the conditions under which the glass and binder mixtures were compounded in a recycled nylon to produce a reinforced polymer. Table 3 provides data relating to various properties of the compositions of Table 2.

Table 4 describes a second trial with additional glass/binder mixtures, some of which are combined with a polyethylene based maleic anhydride impact modifier/chain extender. Table 5 provides the results of compounding the glass/binder/modifier mixture of Table 4 in recycled nylon to produce a reinforced polymer.

TABLE 2
Trial 1 Compounding Parameters

| Extrusion order | 4 | 5 | 6 | 7 |
|---|---|---|---|---|
| Fiber type | HP3610 | HP3610-XM | HP3610 | HP3610-XM |
| Glass Description | E-glass | XM glass | E-glass | XM glass |
| Binder | HP3610 | HP3610 | HP3610 | HP3610 |
| Polymer | PA66 | PA66 | PA66 | PA66 |
| Manufacturer | Ravago | Ravago | Ravago | Ravago |
| Polymer type | PC66LAMCPEL | PC66LAMCPEL | PC66LAMCPEL | PC66LAMCPEL |
| Polymer (kg/hr) | 8.4 | 8.4 | 8.4 | 8.4 |
| Glass (kg/hr) | 3.60 | 3.60 | 3.60 | 3.60 |
| Theoretical glass content | 30 | 30 | 30 | 30 |
| (wt %) | | | | |
| Moisture content | 0.00 | 0.00 | 0.00 | 0.00 |
| Vacuum | −1 | −1 | −1 | −1 |
| Extrusion screw speed | 198 | 198 | 198 | 198 |
| minimum (rpm) | | | | |
| Extrusion screw speed | 202 | 202 | 202 | 202 |
| minimum (rpm) | | | | |
| Torque (visual) | 47-51 | 47-51 | 47-51 | 47-51 |
| Feeding factor (colortronic) | 22.8 | 19.5 | 22.0 | 19.3 |
| T_{M} (° C.) | 257 | 259 | 259 | 259 |
| Zone 1 temp 285 | 262 | 263 | 263 | 263 |
| Zone 2 temp 285 | 282 | 283 | 283 | 282 |
| Zone 3 temp 285 | 271 | 272 | 273 | 272 |
| Zone 4 temp | 274 | 276 | 276 | 276 |

TABLE 3
Trial 2 Mechanical Properties

| Extrusion order | 4 | 5 | 6 | 7 |
|---|---|---|---|---|
| Average glass fiber | 262 | 329 | 248 | 304 |
| length (um) | | | | |
| Charpy impact strength | 51.1 | 52.6 | 51.3 | 54.1 |
| unnotched (kJ/m²) | | | | |
| Tensile strength (MPa) | 157.4 | 165.4 | 159.7 | 164.4 |
| Tensile modulus (MPa) | 10.8 | 11.3 | 11.1 | 11.3 |
| Elongation at break (%) | 2.10 | 2.16 | 2.09 | 2.13 |
| Glass content weight (%) | 30.5 | 30.1 | 31.2 | 30.2 |

TABLE 4
Trial 2 Compounding Parameters

| Extrusion order | 4 | 5 | 6 | 7 |
|---|---|---|---|---|
| Fiber type | HP3610 | HP3610-XM | HP3610 | HP3610-XM |
| Glass Description | E-glass | XM glass | E-glass | XM glass |
| Binder | HP3610 | HP3610 | HP3610 | HP3610 |
| Polymer | PA66 | PA66 | PA66 | PA66 |
| Manufacturer | Ravago | Ravago | Ravago | Ravago |
| Polymer type | PC66LAMCPEL | PC66LAMCPEL | PC66LAMCPEL | PC66LAMCPEL |
| Additive Type | None | None | None | None |
| Additive Name | None | None | None | None |
| Additive amount (weight | 0.00 | 0.00 | 0.00 | 0.00 |
| % on compound) | | | | |
| Polymer (kg/hr) | 8.4 | 8.4 | 8.4 | 8.4 |
| Glass (kg/hr) | 3.60 | 3.60 | 3.60 | 3.60 |
| Theoretical glass content | 30 | 30 | 30 | 30 |
| (wt %) | | | | |
| Moisture content pellets | 0.03 | 0.02 | 0.01 | 0.01 |
| Vacuum | −1 | −1 | −1 | −1 |
| Extrusion screw speed | 198 | 198 | 198 | 198 |
| minimum (rpm) | | | | |
| Extrusion screw speed | 202 | 202 | 202 | 202 |
| minimum (rpm) | | | | |
| Torque (visual) | 46-50 | 46-50 | 46-50 | 46-50 |
| Feeding factor (colortronic) | 21.9 | 18.4 | 21.7 | 18.5 |
| T_{M} (° C.) | 255 | 254 | 254 | 254 |
| Zone 1 temp 285° C. | 261 | 260 | 260 | 260 |
| Zone 2 temp 285° C. | 282 | 281 | 281 | 269 |
| Zone 3 temp 280° C. | 271 | 270 | 269 | 269 |
| Zone 4 temp 280° C. | 273 | 272 | 271 | 272 |
| Extrusion order | 8 | 9 | 10 | 11 |
| Fiber type | HP3610 | HP3610-XM | HP3610 | HP3610-XM |
| Glass Description | E-glass | XM glass | E-glass | XM glass |
| Binder | HP3610 | HP3610 | HP3610 | HP3610 |
| Polymer | PA66 | PA66 | PA66 | PA66 |
| Manufacturer | Ravago | Ravago | Ravago | Ravago |
| Polymer type | PC66LAMCPEL | PC66LAMCPEL | PC66LAMCPEL | PC66LAMCPEL |
| Additive Type | Impact modifier | Impact modifier | Impact modifier | Impact modifier |
| Additive Name | Yparex 0H09 | Yparex 0H09 | Yparex 0H09 | Yparex 0H09 |
| Additive amount (weight | 3.00 | 3.00 | 3.00 | 3.00 |
| % on compound) | | | | |
| Polymer (kg/hr) | 8.4 | 8.4 | 8.4 | 8.4 |
| Glass (kg/hr) | 3.60 | 3.60 | 3.60 | 3.60 |
| Theoretical glass content | 30 | 30 | 30 | 30 |
| (wt %) | | | | |
| Moisture content | 0.01 | 0.02 | 0.02 | 0.00 |
| Vacuum | −1 | −1 | −1 | −1 |
| Extrusion screw speed | 198 | 198 | 198 | 198 |
| minimum (rpm) | | | | |
| Extrusion screw speed | 202 | 202 | 202 | 202 |
| minimum (rpm) | | | | |
| Torque (visual) | 50-55 | 50-55 | 50-55 | 50-55 |
| Feeding factor (colortronic) | 21.8 | 18.4 | 22.0 | 18.6 |
| T_{M} (° C.) | 255 | 254 | 254 | 254 |
| Zone 1 temp 285° C. | 258 | 257 | 257 | 256 |
| Zone 2 temp 285° C. | 282 | 281 | 282 | 280 |
| Zone 3 temp 280° C. | 270 | 268 | 268 | 268 |
| Zone 4 temp 280° C. | 272 | 272 | 272 | 271 |

TABLE 5
Trial 2 Mechanical Properties

| Extrusion order | 4 | 5 | 6 | 7 | 8 | 9 | 10 | 11 |
|---|---|---|---|---|---|---|---|---|
| Average glass fiber | 253 | 324 | 230 | 316 | 266 | 336 | 247 | 393 |
| length (μm) | | | | | | | | |
| MFI (g/10 min) at 275° C. | 12.3 | 13.6 | 15.5 | 14.1 | 6.7 | 8.6 | 10.5 | 10.9 |
| and 2.16 kg | | | | | | | | |
| Charpy impact strength | 6.3 | 7.4 | 6.5 | 7.4 | 7.3 | 8.2 | 7.0 | 8.0 |
| notched (kJ/m²) | | | | | | | | |
| Charpy impact strength | 51.1 | 54.1 | 49.3 | 54.6 | 57.5 | 60.3 | 55.8 | 57.2 |
| unnotched (kJ/m²) | | | | | | | | |
| Tensile strength (MPa) | 153.8 | 162.9 | 152.0 | 161.4 | 144.8 | 152.5 | 139.8 | 146.1 |
| Tensile modulus (MPa) | 10.9 | 11.1 | 10.7 | 11.1 | 10.1 | 10.5 | 9.8 | 10.1 |
| Elongation at break (%) | 2.15 | 2.30 | 2.14 | 2.27 | 2.38 | 2.46 | 2.36 | 2.53 |
| Glass content weight (%) | 30.1 | 29.9 | 30.1 | 30.2 | 30.5 | 29.9 | 29.8 | 29.3 |

Table 6 summarizes the test methods employed for determining mechanical properties of the reinforced polymer.

TABLE 6
Methods for Testing Mechanical Properties

| Property | Method |
|---|---|
| Impact Strength | ISO Charpy Unnotched |
| Tensile Properties | ISO 527 |
| Retained Fiber Length | ISO 22314 |
| Glass Content | ISO 1172 |
| MFI | ASTM D1238, ISO 1133 |
| Tensile Modulus | AST D638, ISO 527 |
| Elongation at Break | ASTM D638, ISO 527 |

It is to be understood that the present description illustrates aspects of the invention relevant to a clear understanding of the invention. Certain aspects of the invention that would be apparent to those of ordinary skill in the art and that, therefore, would not facilitate a better understanding of the invention have not been presented in order to simplify the present description. Although the present invention has been described in connection with certain embodiments, the present invention is not limited to the particular embodiments disclosed, but is intended to cover modifications that are within the spirit and scope of the invention.

1. A composite comprising: from 0.1 to 10 parts by weight of a recycled material per part by weight of a glass composition, wherein the composite has a Vickers hardness greater than or equal to 4.4 gigapascals (GPa).

2. The composite of claim 1, wherein the recycled material comprises nylon.

3. The composite of claim 1 or 2, wherein the glass composition comprises:
from 60 to 62 weight percent SiO₂;
from 14 to 17 weight percent Al₂O₃;
from 14 to 17.5 weight percent CaO;
from 6 to 8.75 weight percent MgO;
from 0 to 1 weight percent TiO₂; and
from 0.5 to 3 weight percent of other constituents.

4. The composite of claim 3, wherein the glass composition further comprises one or more of the following features:
substantially free of Na₂O;
a total content of CaO and MgO (MgO+CaO) greater than 21.5 weight percent;
a K₂O content from 0 to 1 weight percent;
a Li₂O content from 0 to 2 weight percent;
a total content of Na₂O, K₂O, and Li₂O (Na₂O+K₂O+Li₂O) of less than 2 weight percent; and/or
one or more rare earth oxides in an amount from 0.1 to 3 weight percent.

5. The composite of claim 1, further comprising a binder, wherein the binder comprises:
from 6 to 8 weight percent of an aqueous dispersion of an aliphatic non-reactive polyester polyurethane;
from 4 to 6 weight percent poly(ethylene-alt-maleic anhydride);
from 0.1 to 1 weight percent γ-aminopropyltriethoxysilane;
from 0.1 to 1 weight percent neutralizing acid for aminosilane;
from 0.1 to 1 weight percent block copolymer of ethylene oxide and propylene oxide;
from 0.01 to 0.8 weight percent partially amidated polyethylene imine;
from 0.0001 to 0.01 weight percent defoamer; and
remainder deionized water.

6. The composite of claim 1, wherein the glass composition comprises chopped strands.

7. A method for producing a composite comprising: compounding from 0.1 to 10 parts by weight of a recycled material per part by weight of a glass composition, wherein the composite has a Vickers hardness greater than or equal to 4.4 gigapascals (GPa).

8. The method of claim 7, wherein the recycled material comprises nylon.

9. The method of claim 7, wherein the glass composition comprises:
from 60 to 62 weight percent SiO₂;
from 14 to 17 weight percent Al₂O₃;
from 14 to 17.5 weight percent CaO;
from 6 to 8.75 weight percent MgO;
from 0 to 1 weight percent TiO₂; and
from 0.5 to 3 weight percent of other constituents.

10. The method of claim 9, wherein the glass composition further comprises one or more of the following features:
substantially free of Na₂O;
a total content of CaO and MgO (MgO+CaO) greater than 21.5 weight percent;
a K₂O content of from 0 to 1 weight percent;
a Li₂O content from 0 to 2 weight percent;
a total content of Na₂O, K₂O, and Li₂O (Na₂O+K₂O+Li₂O) of less than 2 weight percent; and/or
one or more rare earth oxides in an amount from 0.1 to 3 weight percent.

11. The method of claim 7 or 10, wherein the composite further comprises a binder, wherein the binder comprises:
from 6 to 8 weight percent of an aqueous dispersion of an aliphatic non-reactive polyester polyurethane;
from 4 to 6 weight percent poly(ethylene-alt-maleic anhydride);
from 0.1 to 1 weight percent γ-aminopropyltriethoxysilane;
from 0.1 to 1 weight percent neutralizing acid for aminosilane;
from 0.1 to 1 weight percent block copolymer of ethylene oxide and propylene oxide;
from 0.01 to 0.8 weight percent partially amidated polyethylene imine;
from 0.0001 to 0.01 weight percent defoamer; and
remainder deionized water.

12. The method claim 7, wherein the glass composition comprises chopped strands.

13. An article of manufacture comprising the composite of claim 1.

14. An article of manufacture produced using the method of claim 7.

15. The composite of claim 1, wherein the recycled material comprises a polymeric material.

16. The composite of claim 1, wherein the recycled material comprises carpet.

17. The composite of claim 1, wherein the recycled material comprises a cellulosic material.

18. The composite of claim 1, wherein the recycled material comprises waste paper.

19. The composite of claim 1, wherein the glass composition comprises a yarn.

20. A composite comprising: from 0.1 to 10 parts by weight of a recycled material per part by weight of a glass composition; and
a binder comprising:
from 6 to 8 weight percent of an aqueous dispersion of an aliphatic non-reactive polyester polyurethane;
from 4 to 6 weight percent poly(ethylene-alt-maleic anhydride);
from 0.1 to 1 weight percent γ-aminopropyltriethoxysilane;
from 0.1 to 1 weight percent neutralizing acid for aminosilane;
from 0.1 to 1 weight percent block copolymer of ethylene oxide and propylene oxide;
from 0.01 to 0.8 weight percent partially amidated polyethylene imine;
from 0.0001 to 0.01 weight percent defoamer; and
remainder deionized water,
wherein the glass composition comprises:
from 60 to 62 weight percent SiO₂;
from 14 to 17 weight percent Al₂O₃;
from 14 to 17.5 weight percent CaO;
from 6 to 8.75 weight percent MgO;
from 0 to 1 weight percent TiO₂; and
from 0.5 to 3 weight percent of other constituents,
wherein the composite has a Vickers hardness greater than or equal to 4.4 gigapascals (GPa).
